(19) United States
(12) Patent Application Publication
(10) Pub. No.: US 2016/0072143 A1
(43) Pub. Date: Mar. 10, 2016

(54) HIGH TEMPERATURE ELECTROCHEMICAL SYSTEMS AND RELATED METHODS

(71) Applicant: Fraunhofer USA, Inc., Plymouth, MI (US)

(72) Inventors: Prabhakar Singh, Storrs, CT (US); Steven L. Suib, Storrs, CT (US); Mahesh B. Venkataraman, Wilington, CT (US); Venkata Manthina, Wilington, CT (US); Manoj K. Mahapatra, Wilington, CT (US); Ugur Pasaogullari, Glastonbury, CT (US)

(73) Assignee: Fraunhofer USA, Inc., Plymouth, MI (US)

(21) Appl. No.: 14/821,677

(22) Filed: Aug. 7, 2015

Related U.S. Application Data
(60) Provisional application No. 62/034,668, filed on Aug. 7, 2014.

(51) Int. Cl. H01M 8/06; C25B 15/08; H01M 8/12

(52) U.S. Cl. CPC H01M 8/0687; H01M 8/12; C25B 15/08; H01M 2008/1293

(57) ABSTRACT

High temperature electrochemical systems and methods of capturing Cr species from a gas (e.g., oxidant gas) stream flowing in such systems are described herein.

### RELATED APPLICATIONS

This application claims priority to U.S. Provisional Application No. 62/034,668, filed Aug. 7, 2014, which is incorporated herein by reference in its entirety.

### BACKGROUND

1. Technical Field

The present disclosure relates to high temperature electrochemical systems and methods of capturing Cr species from a gas (e.g., oxidant gas) stream flowing in such systems.

2. Discussion of the Related Art

Chromia (Cr₂O₃) forming stainless steels are extensively used as structural materials in several high temperature energy systems including solid oxide fuel cell (SOFC), solid-oxide electrolyzer cell (SOEC), and oxygen transport membranes (OTM), amongst others. At high temperatures (e.g., >400 C) and in the presence of moisture, Cr₂O₃ tends to convert from +3 oxidation state to +6 oxidation state and form gaseous oxy-hydroxides as shown below:

Cr₂O₃(s)+3/2O₂(g)=2CrO₃(g)

Cr₂O₃(s)+3/2O₂(g)+2H₂O(g)=2CrO₂(OH)₂(g)

Cr₂O₃(s)+1/2O₂(g)+2H₂O(g)=2CrO(OH)₂(g)

Cr-containing vapor species (Cr⁺⁶) are not only harmful from the environmental perspective but also can hinder the operation of these high temperature systems. For example, Cr-oxyhydroxides may react with electrode materials (e.g., perovskite electrode materials such as LSM, LSC, LSF etc.) and block the active sites for O₂ adsorption, leading to significant performance degradation over time. Suggested mechanisms for this degradation include SrCrO₄ or Cr—Mn spinel precipitation and substitution of Mn, Co and Fe at the B-site by Cr, the latter being more prevalent at high temperatures. SrCrO₄ formation can lead to lower conductivity, desification and thermal expansion coefficient mismatch which are detrimental to cathode performance. Similarly, B-site substitution with Cr or Mn—Cr spinel formation can lead to decrease in electrical conductivity, oxygen exchange surface reaction rate and electrochemical activity.

Accordingly, techniques that mitigate the above-noted problems associated with Cr-containing vapor species are desireable.

### SUMMARY OF INVENTION

High temperature electrochemical systems that include a Cr-getter material and methods of capturing Cr from a gas stream are described herein.

In one aspect, a high temperature electrochemical system is provided. The system comprises a high temperature electrochemically active component configured to receive incoming gas and fuel, and including a site for electrochemical reactions; and a Cr-getter material arranged to contact the incoming gas upstream of the site of the electrochemical reactions.

In one aspect, a method is provided. The method comprises contacting an incoming gas comprising chromium gas species at a temperature of greater than 400° C. with a Cr getter material and capturing chromium gas species by a chemical reaction between the chromium gas species and the Cr-getter material. After capturing the chromium gas species, the method further comprises providing the gas species to an electrochemical reaction site.

Other aspects, embodiments and feature are described further below in the Detailed Description and shown in the Figures.

### BRIEF DESCRIPTION OF DRAWINGS

FIG. 1 shows a schematic of a high temperature electrochemical system according to an embodiment.

FIG. 2 shows a schematic of a gas filter assembly including a substrate and a Cr-getter material coating according to an embodiment.

FIG. 3 shows the thermodynamic vapor pressure of the Cr-gaseous species in equilibrium with various Group II oxides according to an embodiment.

FIG. 4 shows show an SEM image depicting the formation of Cr-containing species formed on the surface of SrMnO₃ according to an embodiment.

FIG. 5 shows show an SEM image depicting the formation of Cr-containing species formed on the surface of MnO₂ according to an embodiment.

FIG. 6 shows show an SEM image depicting the formation of Cr-containing species formed on the surface of MgO according to an embodiment.

FIG. 7 shows show an SEM image depicting the formation of Cr-containing species formed on the surface of 3SrO.Al₂O₃+MnO₂ composite.

FIG. 8 shows show an SEM image depicting the formation of Cr-containing species formed on the surface of Sr₉Ni₇O₂₁ according to an embodiment.

### DETAILED DESCRIPTION

High temperature electrochemical systems that include a Cr-getter material and methods of capturing Cr from a gas stream are described herein. Such systems may generate power by oxidizing a fuel in an electrochemical reaction. Examples of such high temperature electrochemical systems include solid oxide fuel cell (SOFC), solid-oxide electrolyzer cell (SOEC), and oxygen transport membranes (OTM), amongst others. The systems offer potential for the development of clean and efficient power generation (SOFC), production of hydrogen and synthesis gas (SOEC), and gas separation for clean combustion (OTM).

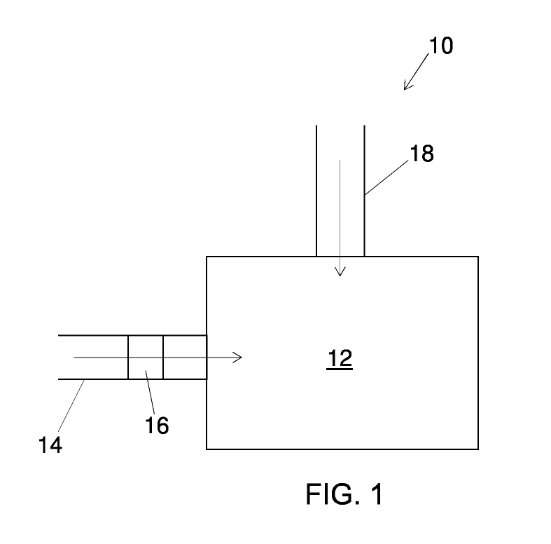

The systems include a variety of components which are configured to perform the different functions needed for such systems to operate. FIG. 1 schematically illustrates a high temperature electrochemical system 10. The system includes a high temperature electrochemically active component 12 in which electrochemical reactions occur. Component 12 is configured to receive incoming gas (e.g., air) through a passageway 14 and fuel through a passageway 18. For example, the fuel may be oxidized in an electrochemical reaction to produce power. The system includes a Cr-getter material 16 which contacts the incoming gas upstream of the site(s) of the electrochemical reactions. As described further below, the Cr-getter material captures chromium gaseous species in the incoming gas by chemical reactions thereby removing such species from the gas stream which otherwise would impair performance of the electrochemical system.

As shown, the Cr-getter material may be positioned in passageway 14. However, it should be understood that the Cr-getter material may be in other suitable locations such that the Cr-getter material contacts the incoming gas at a position upstream of the electrochemical reaction sites. For example, in some embodiments, the Cr-getter material may be positioned in electrochemically active component 12 upstream of the sites of the electrochemical reaction.

Different components of the system (e.g., piping (such as piping that defines passageways 14, 16), heat exchangers, interconnects, combustors, manifolds, and ducting in the balance of plant) may be formed of metals that comprise Cr. For example, the metals may be Fe-based chromia-forming alloys such as steels (e.g., stainless steel). Such metals may be advantageous because of their lower manufacturing cost, physical compatibility, machinability and superior oxidation resistance. However, under typical operating conditions of the systems (e.g., high temperature and presence of water vapor), the chromia protective layer formed on such metals/alloys tends to volatize in the form of gaseous CrO₃ and chromium hydroxyl-oxides (CrO(OH), CrO(OH)₂ CrO₂(OH)₂). The dominant species below 900° C. is CrO₂(OH)₂. If not removed, the Cr-vapor species could potentially impair the electrochemical reactions in the system. For example, the Cr-vapor species could potentially react with electrode materials (e.g., cathode materials such as LSM/LSCF/LSCM) and/or contact paste to form (Cr,Mn)₃O₄ spinel or LaCrOx, which leads to the blockage of the active-sites for oxygen reduction and compound formation with subsequent performance/lifetime reduction.

Some methods described herein comprise capturing the Cr-gas species from the gas stream irrespective of the amount of Cr-vapors emanating from the metallic components. The advantage of such an approach is that cheaper metallic components can be used with focus on other properties such as creep resistance, electrical conductivity of oxide layer etc. In some embodiments, substantially all of the Cr-gaseous species may be captured. For example, the Cr-gaseous species may be removed to partial pressures of less 1 ppb, or less than 1 ppt. The concentration of Cr-gaseous species may be reduced by a factor of ×1000 to ×10,000 in the equilibrium partial pressure. It should be understood that in some embodiments not substantially all of the Cr-gaseous species are removed and that insignificant amounts remain in the gaseous stream.

The Cr-getter material may have a variety of suitable compositions. In general, the material need to be sufficiently reactive with Cr-gaseous species to enable reduction of the Cr-gaseous species to the desired amount. The getter materials may react with the Cr-gaseous species to form thermodynamically stable (e.g., under the operating conditions) Cr compounds. Such compounds effectively capture Cr.

Some embodiments utilize the concept of acid-base reaction with strongly basic oxides reacting with the acidic Cr gaseous species to form highly stable compounds with corresponding free energy changes. Most basic oxides have a strong affinity for reacting with gaseous Cr-species (slightly acidic) thus forming highly stable chromate and chromite at high temperatures. Such materials may provide an attractive proposition of capturing or “gettering” the Cr-species from the gas stream through a gas-solid reaction. Additionally, the Cr atom can preferentially displace transition metal (present on the B site) from the octahedral sites in spinel and perovskite structures.

In some embodiments, the Cr-getter material comprises a material (e.g., Group II metal oxides) selected from the group consisting of MgO, CaO, SrO, BaO and combinations thereof.

In some embodiments, the Cr-getter material comprises further comprises one or more additional metal oxide material. The one or more additional metal oxide materials comprise MnOₓ, Al₂O₃, FeOₓ, CoOₓ, NiO, Ni₂O₃, and combinations thereof. The Cr-getter material and the one or more additional metal oxide materials may form a composite. For example, the one or more additional metal oxides are in unreacted form. The Cr-getter material and the one or more one or more additional metal oxides may form spinel or multiple complex oxide phases.

In some embodiments, the Cr-getter material comprises a manganese oxide spinel, and/or modified compounds of the above namely strontium manganite (Sr₍₁₋ₓ₎MₓMnO₃, where 0<x<0.2 and M comprises Ce, La, Pr and Sm). Some of the pure Group II oxides like SrO and BaO may readily hydrolyze even in ambient conditions. The Cr-material may also comprise oxide composites containing group II oxides (AO) and other metal oxides (BO), e.g., Fe, Ni, Mn, Al, Co etc. or combination of these in any proportion such that AO may provide the primary gettering capability and BO may provide additional gettering and sintering aid, prevention of hydrolysis and/or surface modification of substrate for coating uniformity/stability.

In some embodiments, the Cr-getter material comprises perovskite oxides of the form ABO₃. In some cases, A may comprise at least one or more of cations selected from the group consisting of Mg, Ca, Sr, Ba and combinations thereof. In some cases, B comprises at least one or more cations selected from the group consisting of Al, Fe, Mn, Ni, Co and combinations thereof.

In some embodiments, the reaction mechanism for Cr capture is:

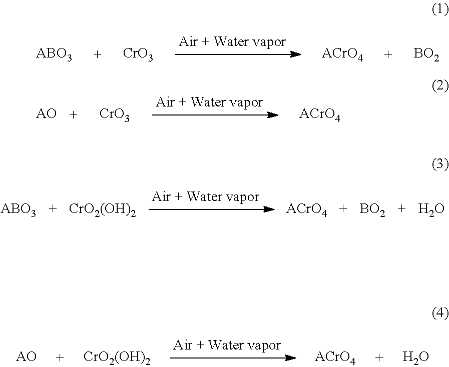

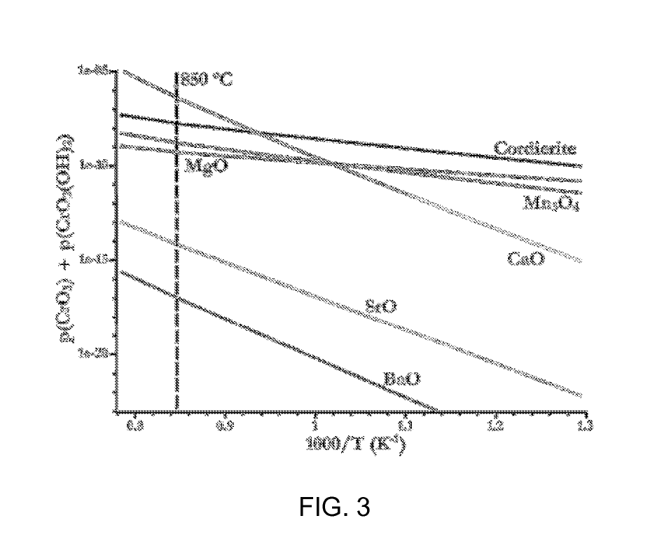

FIG. 3 shows the thermodynamic vapor pressure of the Cr-gaseous species in equilibrium with various Group II oxides. Using these thermodynamic values as guidelines, getter compositions were designed with compositions as described previously.

The Cr-getter material may be present in a variety of forms. In general, the Cr-getter material is in a form that enables it to be positioned in the incoming gas stream so that the Cr-getter material is in contact with the gas. For example, the Cr-getter material may be incorporated into a gas filtering assembly. The filter assembly may be arranged in the system so that the incoming gas containing Cr-species passes through the filter assembly and is in contact with the Cr-getter material.

In some embodiments, the Cr-getter material may be part of a coating formed on a substrate. The coating may be formed on a substrate to form a component (e.g., filter assembly). In some cases, the coatings may be formed on a component of the system itself which functions as the substrate. The components may have a variety of shapes and sizes which offer additional flexibility in terms of integration within a wide range of electrochemical system (size range, system configuration, operation conditions etc.). For example, the component (and/or Cr-getter material) may have a cylindrical shape or a rectangular shape, amongst others. The component (and/or Cr-getter material) may have dimensions (e.g., length) on the order of millimeters, centimeters or meters, amongst others.

In some cases, the coating is formed entirely of the Cr-getter material. The Cr-getter material may be in the form of a high surface area powder that forms a coating on a substrate.

The Cr-getter material may have a surface area that is greater than 5 m²/g and, in some cases, between 5 m²/g and 10 m²/g. In some embodiments, the Cr-getter material has an average particle size between 10 nm and 2 micron; and, in some embodiments, between 50 nm and 100 nm. The Cr-getter material may be in the form of a plurality of particles that are interconnected to form a porous network, e.g., through which the gas can flow.

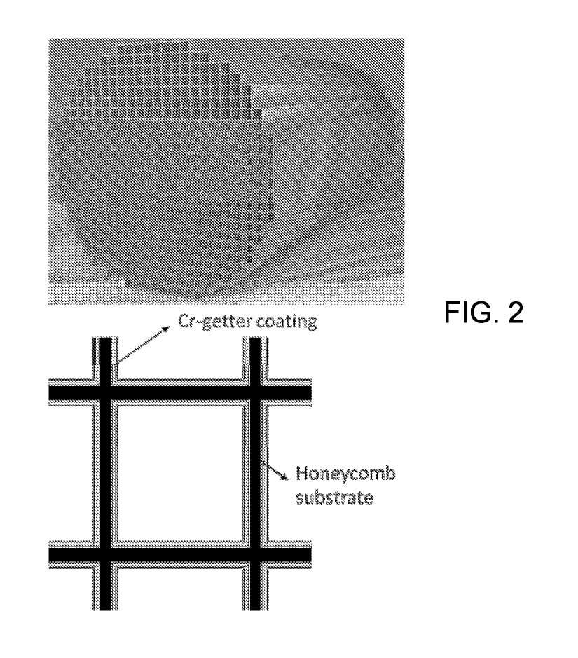

In embodiments in which the Cr-getter material is formed as a coating on a substrate, the substrate may comprise a metal or ceramic material. In some cases, the substrate comprises a material selected from the group consisting of cordierite, alumina, silica, zirconia, and ceria. The substrate may comprise an open cell foam material. In some embodiments, the substrate comprises a structure including one or more channels. For example, the structure may comprise a honeycomb as shown schematically in FIG. 2

In some embodiments, the Cr-getter materials may be in bulk form. That is, not as a coating. For example, the bulk Cr-getter materials may be a mesh and/or a screen.

The Cr-getter materials may be formed in a variety of known processes including sol-gel processes, amongst others including CVD processes or processes that involve depositing a slurry on a substrate. Some processes involving coating the Cr-getter materials on a substrate. In some embodiments, the coating methodology used may be solution gelation with nitrate salts as precursors. The sol-gel technique is easy to scale-up for industrial operations and can be used to uniformly coat complex shapes with precise control on coating thickness. The coating may be heat treated, in some embodiments, to promote adhesion to the substrate and/or preserve the high surface area of the coating.

The high temperature electrochemical systems operate at temperatures of greater than 400° C.; in some cases, between 450° C. and 1200° C.; and in some cases, between 600° C. and 1000° C. It should be understood that the gas (e.g., air) may be heated to such temperatures prior to the electrochemical reaction. Also, the electrochemical reactions may occur at such temperatures.

In general, the electrochemical reaction occurs within the electrochemically active component of the system. In some embodiments, the electrochemically active component comprises an electrochemical cell. For example, the electrochemically active component may comprise an electrode; and, in some embodiments, a cathode and an anode. The electrochemically active component may include a stack of materials and/or layers. The electrochemical systems may generate power by oxidizing a fuel in an electrochemical reaction.

### EXAMPLES

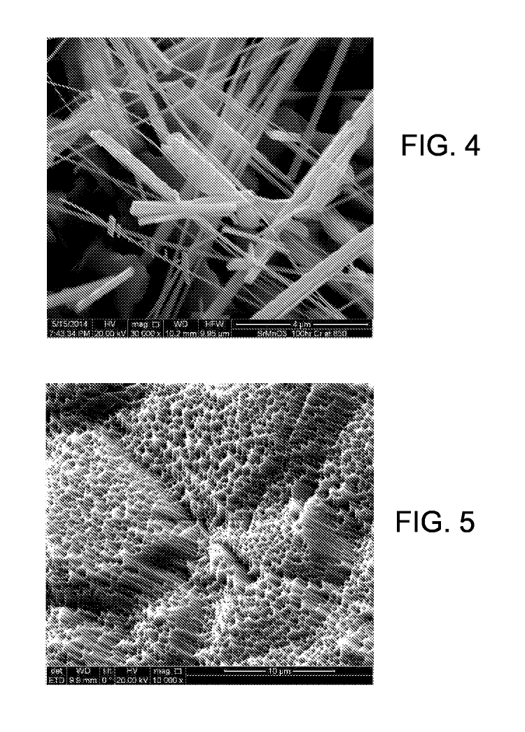

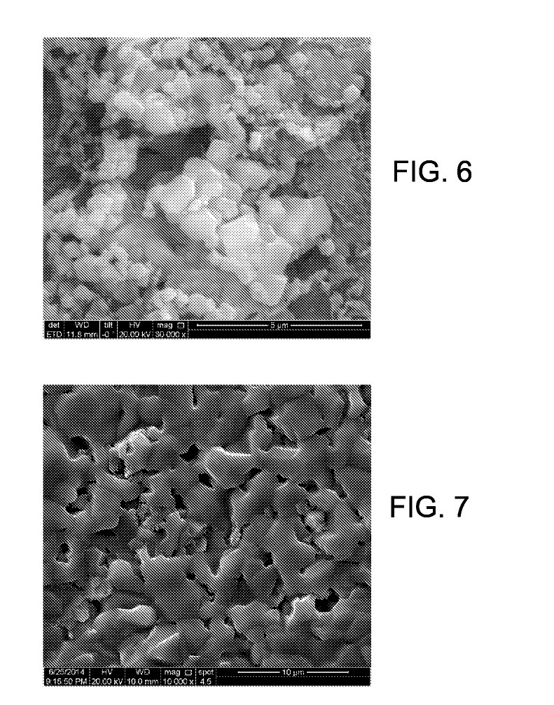

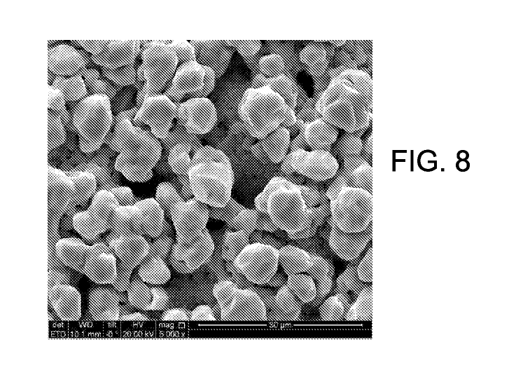

FIGS. 4-8 show the SEM images depicting the formation of Cr-containing species formed on the surface of different Cr-getter materials, namely SrMnO₃, MnO₂, MgO, 3SrO.Al₂O₃+MnO₂ composite and Sr₉Ni₇O₂₁. The EDS-scans confirm the formation of stable Cr-compounds like SrCrO₄, Mn,Cr₍₂₋ₓ₎O₄, MgCr₂O₄ showing the strong gettering capacity of various oxide phases.

1. A high temperature electrochemical system comprising:
a high temperature electrochemically active component configured to receive incoming gas and fuel, and including a site for electrochemical reactions; and
a Cr-getter material arranged to contact the incoming gas upstream of the site of the electrochemical reactions.

2. The system of claim 1, further comprising at least one passageway configured to provide incoming gas to the electrically active component, wherein the Cr-getter material is arranged in a passageway upstream of the electrically active component.

3. The system of claim 1, wherein the Cr-getter material is arranged in the high temperature electrically active component.

4. The system of claim 1, further comprising one or more components formed of a metal that comprises Cr, and the one or more components are exposed to the incoming gas upstream of the site of the electrochemical reactions.

5. The system of claim 4, wherein the one or more components are selected from the group consisting of piping, heat exchangers, gas manifolds, interconnects, combustors, ducting in the balance of plant, and combinations thereof.

6. The system of claim 1, wherein the one or more components are formed of a material that comprises steel.

7. The system of claim 1, wherein the incoming gas comprises air.

8. The system of claim 1, wherein the incoming gas is at a temperature of greater than 400° C.

9. The system of claim 1, further comprising a gas filtering assembly that includes the Cr-getter material.

10. The system of claim 1, wherein the Cr-getter material is a coating on a substrate.

11. The system of claim 10, wherein the substrate comprises a metal or ceramic material.

12. The system of claim 10, wherein the substrate comprises a material selected from the group consisting of cordierite, alumina, silica, zirconia, and ceria.

13. The system of claim 10, wherein the substrate comprises an open cell foam.

14. The system of claim 10, wherein the substrate comprises a structure including one or more channels.

15. (canceled)

16. The system of claim 11, wherein the Cr-getter material is in bulk form.

17. (canceled)

18. The system of claim 1, wherein the incoming gas is the oxidant gas for the high temperature electrochemical system.

19. The system of claim 1, wherein incoming gas flow path is aligned with the Cr-getter material for at least a distance upstream of the high temperature electrochemically active component.

20. The system of claim 1, wherein the Cr-getter material comprises a material selected from the group consisting of MgO, CaO, SrO, BaO and combinations thereof.

21-25. (canceled)

26. The system of claim 1, wherein the high temperature electrochemically active component comprises an electrochemical cell.

27-28. (canceled)

29. A method comprising:
contacting an incoming gas comprising chromium gas species at a temperature of greater than 400° C. with a Cr getter material;
capturing chromium gas species by a chemical reaction between the chromium gas species and the Cr-getter material; and
after capturing the chromium gas species, providing the gas species to an electrochemical reaction site.

30-33. (canceled)
